(19) United States
(12) Patent Application Publication
(10) Pub. No.: US 2022/0274438 A1
(43) Pub. Date: Sep. 1, 2022

(54) ELECTRONIC MECHANICAL PENCIL

(71) Applicant: NEOLAB CONVERGENCE, INC., Seoul (KR)

(72) Inventor: Bong Ki PARK, Yongin-si (KR)

(21) Appl. No.: 17/637,866

(22) PCT Filed: Aug. 24, 2020
(86) PCT No.: PCT/KR2020/011247

§ 371 Date: Feb. 24, 2022

(30) Foreign Application Priority Data
Sep. 2, 2019 (KR) 10-2019-0108113

(51) Int. Cl. B43K 29/08; B43K 29/00; B43K 21/00

(52) U.S. Cl. CPC B43K 29/08; B43K 29/003; B43K 21/003

(57) ABSTRACT

Disclosed is an electronic mechanical pencil including: a first body part for accommodating a mechanical pencil cartridge for enabling writing through a mechanical pencil lead provided therein, a camera module capable of recognizing a user's writing through the mechanical pencil cartridge, a board part connected to the camera module, a power supply part for supplying power to the board part and the camera module; and a second body part for accommodating a push button part for drawing out the mechanical pencil lead from the mechanical pencil cartridge, and a pressure sensor part coupled to a lower end of the push button part and capable of coming into contact with the mechanical pencil cartridge in order to detect pressure of the mechanical pencil cartridge against a paper, wherein the first body part and the second body part are separated from each other in order to refill the mechanical pencil cartridge.

### TECHNICAL FIELD

The present invention relates to an electronic mechanical pencil, and more particularly, to an electronic mechanical pencil in which a body of the electronic mechanical pencil is separated for replacement of a mechanical pencil cartridge or refilling of a mechanical pencil lead.

### BACKGROUND ART

Recently, when an electronic pen is used to write on a note or printed matter with or without a code, a technology for digitally restoring writing in a device such as a smartphone has been disclosed. When an electronic pen is used to write on printed matter with a code, the electronic pen obtains code information by reading the code along the trajectory of stroke, and then transmits the code information to an external device connected to the electronic pen. The external device detects location information of the stroke according to the received code information, generates a writing trajectory according to the location information, and displays the generated writing trajectory on a screen.

Currently, ink cartridge pen tips containing ink are used. In this case, the pen tip is fixed by a magnet included in an electronic pen, and the pen tip is removed from the electronic pen so as to be replaced.

However, in the case of a mechanical pencil cartridge, a spring structure is used to draw out a mechanical pencil lead. In order to draw out the mechanical pencil lead, external force has to be applied downward with respect to the mechanical pencil cartridge. In this case, a structure capable of supporting the lower end of the mechanical pencil cartridge is required in order for elastic force to act on a spring in the mechanical pencil cartridge. The mechanical pencil cartridge has to be ejected to refill the mechanical pencil lead. However, when the mechanical pencil cartridge is applied to the current electronic pen structure, it is impossible to eject the mechanical pencil cartridge, or it is difficult to refill the mechanical pencil lead. Therefore, there is a need to design a new structure of electronic pen in order to apply a mechanical pencil cartridge to an electronic pen.

### DESCRIPTION OF EMBODIMENTS

### Technical Problem

The present invention aims to provide an electronic mechanical pencil having a structure in which, when a mechanical pencil cartridge is applied to an electronic pen, a body of the electronic pen is separated in order to facilitate refilling or replacement of a mechanical pencil cartridge.

### Solution to Problem

For an electronic pen having a structure in which a body of the electronic pen is separated in order to facilitate refilling or replacement of a mechanical pencil cartridge, an electronic mechanical pencil according to the present invention includes a mechanical pencil cartridge, a camera module, a board part, a power supply part, a push button part, and a pressure sensor part, wherein the first body part accommodates the mechanical pencil cartridge, the camera module, the board part, and the power supply part, the second body part accommodates the push button part and the pressure sensor part, and the first body part and the second body part are separated from each other.

### Advantageous Effects of Disclosure

According to the present invention, since a body of an electronic pen is separated, a user may easily refill a mechanical pencil lead or replace a mechanical pencil cartridge.

In addition, according to the present invention, the center of gravity is lowered by arranging a battery at a lower portion of an electronic mechanical pencil, thereby increasing the stability of writing.

Furthermore, according to the present invention, information of the mechanical pencil cartridge is detected by an identifier of the mechanical pencil cartridge, thereby increasing user convenience.

### BRIEF DESCRIPTION OF DRAWINGS

FIGS. 1 and 2 are diagrams schematically illustrating a structure of an electronic mechanical pencil according to an embodiment of the present invention.

FIG. 3 is a diagram illustrating a mechanical pencil cartridge.

FIGS. 4 and 5 are diagrams schematically illustrating a structure of an electronic mechanical pencil according to another embodiment of the present invention.

FIG. 6 is a diagram schematically illustrating a structure of an electronic mechanical pencil according to another embodiment of the present invention.

FIGS. 7 and 8 are diagrams schematically illustrating a structure of an electronic mechanical pencil according to another embodiment of the present invention.

### BEST MODE

According to an embodiment of the present invention, in order to solve the above technical problems, an electronic mechanical pencil includes: a mechanical pencil cartridge for enabling writing through a mechanical pencil lead provided therein; a camera module capable of recognizing a user's writing through the mechanical pencil cartridge; a board part connected to the camera module; a power supply part for supplying power to the board part and the camera module; a first body part for accommodating the mechanical pencil cartridge, the camera module, the board part, and the power supply part; a push button part for drawing out the mechanical pencil lead from the mechanical pencil cartridge; a pressure sensor part coupled to a lower end of the push button part and capable of coming into contact with the mechanical pencil cartridge in order to detect pressure of the mechanical pencil cartridge against a paper; and a second body part for accommodating the push button part and the pressure sensor part, wherein the first body part and the second body part are separated from each other.

The first body part and the second body part may be connected to each other through a hinge.

A certain identifier may be printed on an outer peripheral surface of the mechanical pencil cartridge, and the first body part may further include a cartridge detection part capable of detecting information about the mechanical pencil cartridge by recognizing the certain identifier.

The electronic mechanical pencil may further include a cap that is coupled to one end of the first body part, has a hole that enables the camera module to recognize writing, and includes an eraser at one end.

According to another embodiment of the present invention, in order to solve the above problems, an electronic mechanical pencil includes: a mechanical pencil cartridge enabling writing through a mechanical pencil lead provided therein; a camera module capable of recognizing a user's writing through a mechanical pencil tip; a board part connected to the camera module; a power supply part for supplying power to the board part and the camera module; a push button part for drawing out a mechanical pencil lead from the mechanical pencil cartridge; a pressure sensor part coupled to a lower end of the push button part and capable of coming into contact with the mechanical pencil cartridge in order to detect pressure of the mechanical pencil cartridge against a <Bold>paper</Bold>; and a main body part for accommodating the mechanical pencil cartridge, the camera module, the board part, the power supply part, the push button part, and the pressure sensor part, wherein a lower end of the main body part is separable.

### Mode for Invention

Preferred embodiments of the present invention will be described in detail with reference to the accompanying drawings.

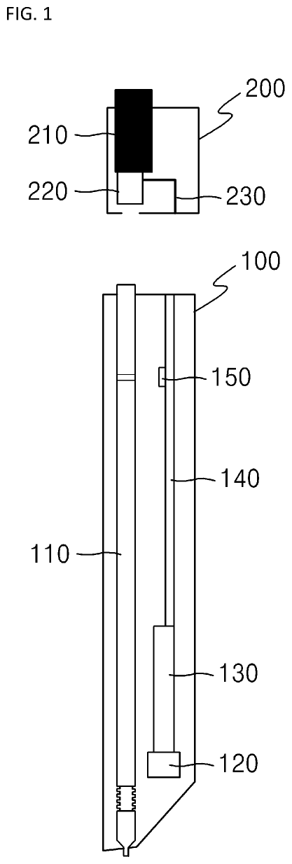

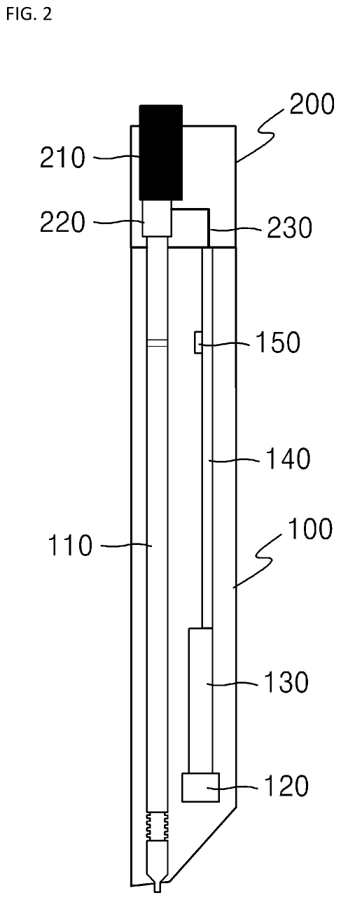

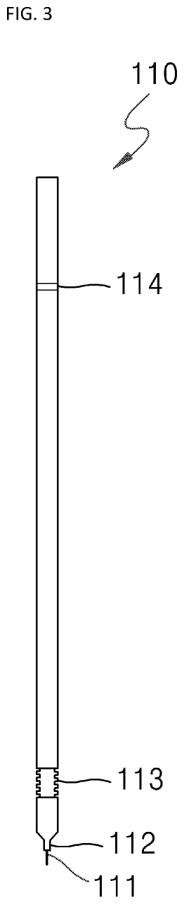

FIGS. 1 and 2 are diagrams schematically illustrating a structure of an electronic mechanical pencil according to an embodiment of the present invention, and FIG. 3 is a diagram illustrating a mechanical pencil cartridge. FIG. 1 illustrates a state in which a first body part and a second body part of the electronic mechanical pencil are separated from each other, and FIG. 2 illustrates a state in which the first body part and the second body part are coupled to each other.

Referring to FIGS. 1 and 2, the electronic mechanical pencil includes a first body part 100 and a second body part 200. The first body part 100 accommodates a mechanical pencil cartridge 110, a camera module 120, a power supply part 130, and a board part 140, and the second body part 200 accommodates a push button part 210 and a pressure sensor part 220.

Referring to FIG. 3, the mechanical pencil cartridge 110 enables writing on a paper by drawing out a mechanical pencil lead 111 provided therein to a mechanical pencil nib 112 provided at one end of the mechanical pencil cartridge 110. A spring 113 is used to draw out the mechanical pencil lead 111. When the spring 113 is operated by applying external force downward with respect to the mechanical pencil cartridge 110, the mechanical pencil lead 111 is drawn out from the mechanical pencil nib 112 by a certain length. In this case, in order for elastic force to act on the spring 113 in the mechanical pencil cartridge 110, there is a need for a structure capable of supporting one end of the mechanical pencil cartridge 110. Therefore, the mechanical pencil cartridge 100 has a structure in which the upper portion of the mechanical pencil nib 112 is widened, and the widened portion is supported by the first body part 100. The mechanical pencil nib 122 of the mechanical pencil cartridge 100 is exposed at one end of the first body part 100.

The camera module 120 may recognize a user's writing on the paper. The camera module 120 obtains an image of a certain code provided on the paper or the like at a certain time interval while the electronic mechanical pencil is moving, and obtains coordinate information of a position of the electronic mechanical pencil and coordinate movement information by analyzing a pattern of the code included in the obtained image. The electronic mechanical pencil may recognize a writing trajectory by using the obtained coordinate information and coordinate movement information.

Although not illustrated, the electronic mechanical pencil may further include a lighting module. The lighting module irradiates light of a specific frequency toward the paper or the like on which writing is performed, so that the camera module 120 may obtain the image of the code printed on the paper or the like. For example, the code printed on the paper or the like is printed with infrared absorbing ink. In this case, the lighting module is configured to irradiate light that may be absorbed by the ink, and the camera module 120 is configured to capture an image for an infrared band. The camera module 120 may include an infrared filter that passes only the infrared band.

The board part 140 is connected to the camera module 120 and includes a controller capable of controlling all components and operations of the electronic mechanical pencil. In addition, the board part 140 may further include other components or other modules necessary for the operations of the electronic mechanical pencil. For example, the board part 140 may further include a communication module (not illustrated) capable of communicating with a display device connected to the electronic mechanical pencil. Alternatively, the communication module may be separately disposed at a different position of the first body part 100, or may be separately disposed in the second body part 200. The communication module transmits, to the external display device, coordinate information or coordinate movement information analyzed based on the image recognized by the camera module 120. The display device receiving the coordinate information or the coordinate movement information restores the user's writing based thereon and displays and provides the restored writing to the user.

The power supply part 130 supplies power to all components that require power, such as the camera module 120 and the board part 140. According to an embodiment of the present invention, the power supply part 130 may be disposed at the lower end of the electronic mechanical pencil, for example, at the upper end of the camera module, in order to achieve a low center of gravity.

The first body part 100 may further include a cartridge detection part 150. The cartridge detection part 150 detects information about the mechanical pencil cartridge 110 by detecting and recognizing an identifier 114 printed on the outer peripheral surface of the mechanical pencil cartridge 110, for example, a certain code. The identifier 114 indicates information about the type of the mechanical pencil cartridge 110 (for example, the thickness, color, or grade of the mechanical pencil lead). The cartridge detection part 150 may sense the identifier 114 through various methods such as optical or magnetic methods. The information about the mechanical pencil cartridge 110, which is sensed by the cartridge detection part 150, is provided to the user.

The mechanical pencil cartridge 110, the camera module 120, the power supply part 130, the board part 140, and the cartridge detection part 150 described above are accommodated in the first body part 100.

A push button part 210 is pushed to apply external force to the mechanical pencil cartridge 110 in order to draw out the mechanical pencil lead from the mechanical pencil cartridge 110. When the push button part 210 is pushed by a certain depth, the mechanical pencil lead is drawn out by a certain length, and then, the push button part 210 returns to an original position. The upper end of the push button part 220 is exposed at one end of the second body part 200.

The pressure sensor part 220 is provided at the lower end of the push button part 210, and may be into contact with the other end of the mechanical pencil cartridge 110 accommodated in the first body part 100. The pressure sensor part 220 may detect pressure generated when the user writes. That is, when the user writes with the electronic mechanical pencil, the pressure sensor part 220 may detect pressure generated when the electronic mechanical pencil, that is, the mechanical pencil cartridge 110 comes into the writing surface. The electronic mechanical pen may detect whether writing is performed by using the pressure value detected through the pressure sensor part 220, and the detection result may be used to generate the writing trajectory.

The second body part 200 accommodates the push button part 210 and the pressure sensor part 220. In addition, the second body part 200 may further include a connection line 230 for connecting the pressure sensor part 220 to the board part 140 of the first body part 100.

According to an embodiment of the present invention, the first body part 100 and the second body part 200 are separated from each other. When the mechanical pencil cartridge of the present invention is applied to an existing electronic pen structure, it is impossible to eject the mechanical pencil cartridge or to refill the mechanical pencil lead in the mechanical pencil cartridge. Therefore, since the second body part 200 is provided in a separate structure, it is possible to refill the mechanical pencil lead in the other end of the mechanical pencil cartridge 110 of the first body part 100 or to eject and replace the mechanical pencil cartridge 110 itself in a state in which the second body part 200 is separated.

Thereafter, the user uses the integrated electronic mechanical pencil by firmly coupling the other end of the first body part 100 and the other end of the second body part 200 through a certain coupling structure.

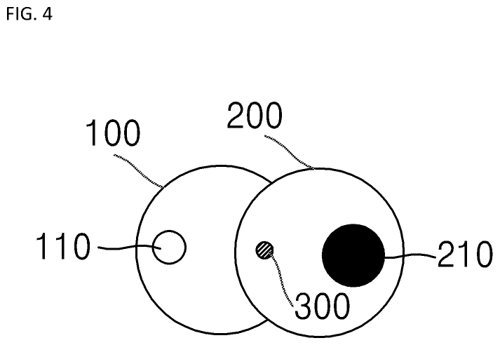

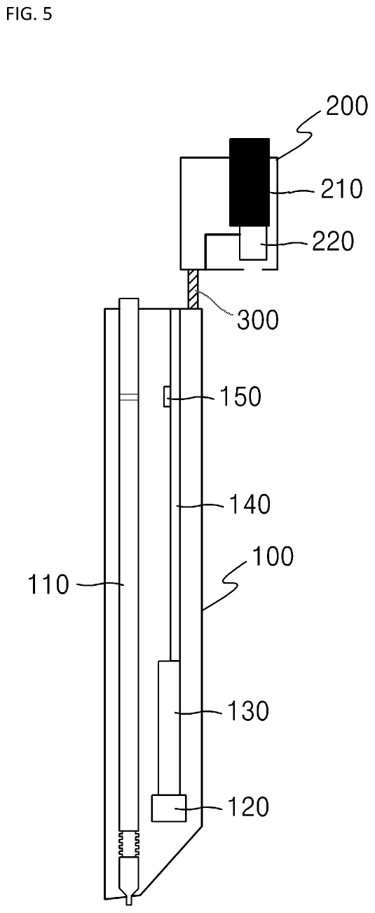

FIGS. 4 and 5 are diagrams schematically illustrating a structure of an electronic mechanical pencil according to another embodiment of the present invention. FIG. 4 is a top view of the electronic mechanical pencil, and FIG. 5 is a side view of the electronic mechanical pencil.

Referring to FIGS. 4 and 5, a first body part 100 and a second body part 200, which are separated from each other, may be connected through a hinge 300. One end of the hinge 300 is disposed to be caught inside the first body part 100, and the other end of the hinge 300 is disposed to be caught inside the second body part 200. The first body part 100 and the second body part 200 are separated from each other, but may be disposed adjacent to each other within the allowable range of the hinge. The first body part 100 or the second body part 200 may be moved up and down according to the length of the hinge 300. Since the other end of the mechanical pencil cartridge 110 of the first body part 100 may protrude, the first body part 100 or the second body part 200 may be moved in an upward or downward direction and coupled to each other.

When the first body part 100 and the second body part 200 are separated from each other, the user has a risk of loss. When the first body part 100 and the second body part 200 are connected to each other through the hinge 300, the first body part 100 and the second body part 200 exists adjacent to each other, and therefore, the user avoids the risk of losing either the first body part 100 or the second body part 200.

In another embodiment of the present invention, a push button part 210 and a pressure sensor part 220 of the second body part 200 may be disposed downward. As illustrated in FIG. 4, when the first body part 100 and the second body part 200 are in an open state, the push button part 210 and the pressure sensor part 220 may move upward due to a mechanical or electronic operation. As illustrated in FIG. 5, when the push button part 210 and the pressure sensor part 220 are coupled to each other, the push button part 210 and the pressure sensor part 220 may move downward due to a mechanical or electronic operation. In addition, the other ends of the first body part 100 and the second body part 200 may have oblique surfaces corresponding to each other.

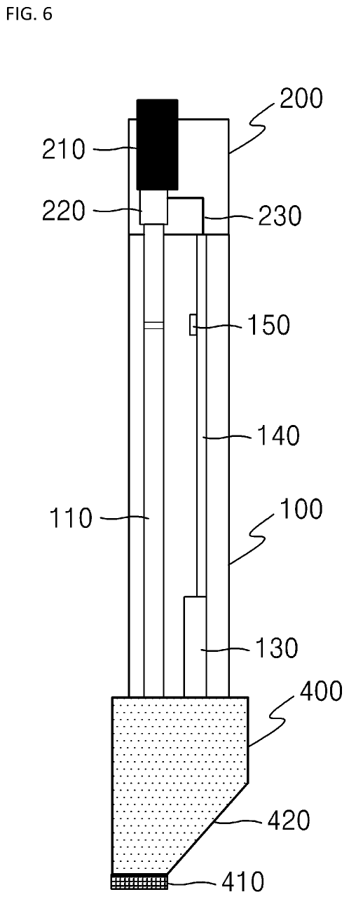

FIG. 6 is a diagram schematically illustrating a structure of an electronic mechanical pencil according to another embodiment of the present invention.

Referring to FIG. 6, the electronic mechanical pencil may further include a cap 400. The cap 400 is fitted to one end of a first body part 100, that is, one end of a mechanical pencil cartridge 110 and a portion onto which a camera module 120 irradiates light.

An eraser 410 may be provided at the end of the cap 400. In this case, by fitting the cap 400, the user may use the electronic mechanical pencil as an eraser.

The cap 400 may have a hole 420 so that the camera module 120 can recognize the writing, that is, the camera module 120 can obtain an image of a paper on which the writing is performed. A transparent window may be disposed in the hole 420.

The cap 400 may include an identifier. By recognizing the identifier, the electronic mechanical pencil may recognize that the cap 400 is fitted. For example, a magnet is disposed in a certain portion of the cap 400, and the electronic mechanical pencil includes a module capable of detecting magnetic force. When the electronic mechanical pencil detects the magnetic force, the electronic mechanical pencil may recognize that the cap 400 is fitted.

When the electronic mechanical pencil with the cap 400 fitted thereon moves on the paper or the like, the camera module 120 obtains an image from the paper or the like and interprets coordinate information based on the obtained image. The electronic mechanical pencil may transmit the coordinate information to a display device capable of communicating with the electronic mechanical pencil, and the display device may operate in an eraser mode for erasing the displayed writing trajectory along the moving trajectory of the electronic mechanical pencil based on the coordinate information.

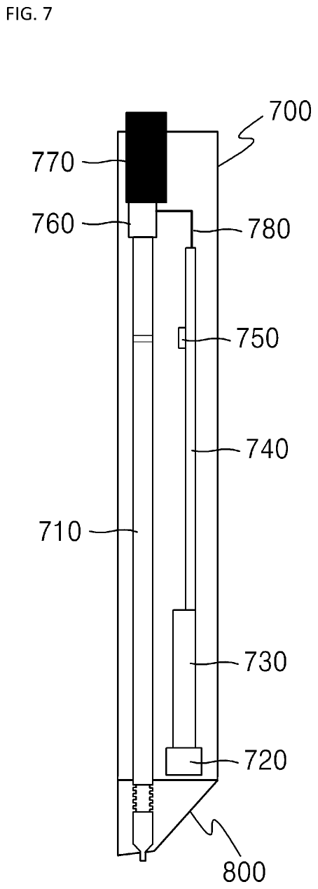

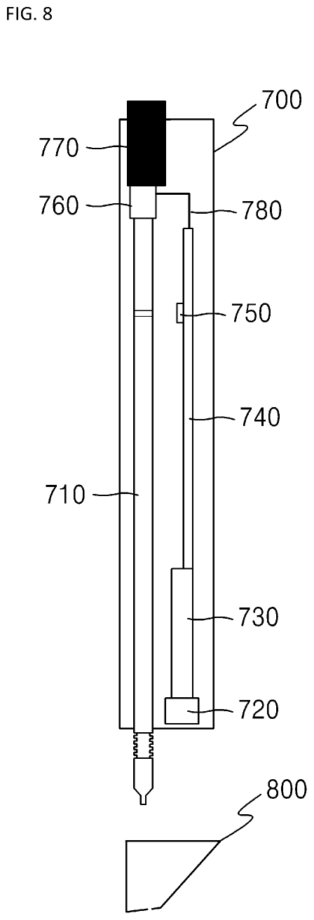

FIGS. 7 and 8 are diagrams schematically illustrating a structure of an electronic mechanical pencil according to another embodiment of the present invention. FIG. 7 is a diagram illustrating an entire main body part of the electronic mechanical pencil, and FIG. 8 is a diagram illustrating a state in which a portion of the lower end of the main body part of the electronic mechanical pencil is separated.

Referring to FIGS. 1 and 2, the components of the electronic mechanical pencil are disposed separately in the first body part 100 and the second body part 200. However, referring to FIGS. 7 and 8, a mechanical pencil cartridge 710, a camera module 720, a power supply part 730, a board part 740, a cartridge detection part 750, a push button part 770, and a pressure sensor part 760 are all accommodated in a main body part 700. Since the mechanical pencil cartridge 710, the camera module 720, the power supply part 730, the board part 740, the cartridge detection part 750, the push button part 770, and the pressure sensor part 760 perform the same functions as described with reference to FIGS. 1 to 3, the descriptions thereof will be omitted below.

Only a certain portion 800 of the lower end of the main body part 700 may be separated. The mechanical pencil cartridge 710, the camera module 720, the power supply part 730, the board part 740, the cartridge detection part 750, the push button part 770, and the pressure sensor part 760 are not accommodated in the certain portion 800 of the lower end.

According to an embodiment of the present invention, even in this case, it is possible to eject and replace the mechanical pencil cartridge 710 itself by separating only the certain portion 800 of the lower end.

Thereafter, the user uses the integrated electronic mechanical pencil by firmly coupling the certain portion 800 of the lower end to the main body part 700 through a certain coupling structure.

The present invention has been described with reference to the preferred embodiments. It will be understood that those of ordinary skill in the art can modify the present invention without departing from the essential features of the present invention. Therefore, the disclosed embodiments should be considered in an illustrative sense rather than a restrictive sense. The scope of the present invention is indicated in the claims rather than the foregoing description, and all differences within the scope equivalent thereto should be construed as falling within the present invention.

1. An electronic mechanical pencil comprising:
a mechanical pencil cartridge for enabling writing through a mechanical pencil lead provided therein;
a camera module capable of recognizing a user's writing through the mechanical pencil cartridge;
a board part connected to the camera module;
a power supply part for supplying power to the board part and the camera module;
a first body part for accommodating the mechanical pencil cartridge, the camera module, the board part, and the power supply part;
a push button part for drawing out the mechanical pencil lead from the mechanical pencil cartridge;
a pressure sensor part coupled to a lower end of the push button part and capable of coming into contact with the mechanical pencil cartridge in order to detect pressure of the mechanical pencil cartridge against a paper; and
a second body part for accommodating the push button part and the pressure sensor part,
wherein the first body part and the second body part are separated from each other.

2. The electronic mechanical pencil of claim 1, wherein the first body part and the second body part are connected to each other through a hinge.

3. The electronic mechanical pencil of claim 1, wherein a certain identifier is printed on an outer peripheral surface of the mechanical pencil cartridge, and the first body part further comprises a cartridge detection part capable of detecting information about the mechanical pencil cartridge by recognizing the certain identifier.

4. The electronic mechanical pencil of claim 1, further comprising a cap that is coupled to one end of the first body part, has a hole that enables the camera module to recognize writing, and includes an eraser at one end.

5. An electronic mechanical pencil comprising:
a mechanical pencil cartridge for enabling writing through a mechanical pencil lead provided therein;
a camera module capable of recognizing a user's writing through a mechanical pencil tip;
a board part connected to the camera module;
a power supply part for supplying power to the board part and the camera module;
a push button part for drawing out a mechanical pencil lead from the mechanical pencil cartridge;
a pressure sensor part coupled to a lower end of the push button part and capable of coming into contact with the mechanical pencil cartridge in order to detect pressure of the mechanical pencil cartridge against a paper; and
a main body part for accommodating the mechanical pencil cartridge, the camera module, the board part, the power supply part, the push button part, and the pressure sensor part,
wherein a lower end of the main body part is separable.
